(19) United States
(12) Patent Application Publication
(10) Pub. No.: US 2023/0239109 A1
(43) Pub. Date: Jul. 27, 2023

(54) COMMUNICATION METHOD AND COMMUNICATION APPARATUS

(71) Applicant: HUAWEI TECHNOLOGIES CO., LTD., Shenzhen (CN)

(72) Inventors: Xiang GAO, Beijing (CN); Xinqian XIE, Beijing (CN); Zhiheng GUO, Beijing (CN)

(21) Appl. No.: 18/185,714

(22) Filed: Mar. 17, 2023

Related U.S. Application Data
(63) Continuation of application No. PCT/CN2021/113596, filed on Aug. 19, 2021.

(30) Foreign Application Priority Data
Sep. 18, 2020 (CN) 202010988609.X

(51) Int. Cl. H04L 5/00; H04W 72/0446

(52) U.S. Cl. CPC H04L 5/0051; H04W 72/0446

(57) ABSTRACT

A communication method and a communication apparatus. A terminal device receives first indication information and second indication information from a network device and determines, based on the first indication information and the second indication information, that a first resource in a resource group corresponding to at least one DMRS port in any one of at least one first time unit does not carry a first data signal, and that a second resource in the resource group corresponding to the at least one DMRS port in another time unit in a time unit set other than the at least one first time unit carries the first data signal. The terminal device receives the first data signal from the network device on a third resource in all the time units in the time unit set, where the third resource includes the second resource and does not include the first resource.

### CROSS-REFERENCE TO RELATED APPLICATIONS

This application is a continuation of International Application No. PCT/CN2021/113596, filed on Aug. 19, 2021, which claims priority to Chinese Patent Application No. 202010988609.X, filed on Sep. 18, 2020. The disclosures of the aforementioned applications are hereby incorporated by reference in their entireties.

### BACKGROUND

In some service scenarios, a network device uses a same time-frequency resource to transmit data to a plurality of terminal devices, and data transmitted to one of the terminal devices may become an interference signal of the other terminal devices. Therefore, for accurate data demodulation, after receiving data, the terminal device not only needs to perform channel estimation on a transmission channel (or stream) of the data of the terminal device, but also needs to perform channel estimation on a channel (or stream) used to transmit an interference signal, to perform interference cancellation, so as to accurately demodulate the data of the terminal device.

The terminal device may perform channel estimation through a demodulation reference signal (demodulation reference signal, DMRS). For example, in a scenario in which a plurality of slots are scheduled to transmit data, the network device generally transmits the DMRS only in a first slot, and the terminal device may perform data demodulation in the first slot through the received DMRS. However, in another slot after the first slot, there may be an interference signal transmitted by multiplexing a same time-frequency resource, and the interference signal causes interference to data demodulation of the terminal device. In a related technology, a channel estimation result of the first slot is generally reused to demodulate data. However, in practice, a time resource occupied by the interference signal is variable, that is, a DMRS port occupied by another terminal device in a subsequent slot may be different from that in the first slot, so the method of reusing the channel estimation result cannot flexibly match a pairing status, resulting in less accurate data demodulation. Therefore, the problem of low accuracy of data demodulation exists in the related technology.

### SUMMARY

Embodiments described herein provide a communication method and a communication apparatus, to improve accuracy of data demodulation.

According to a first aspect, a communication method is provided. The method is applied to a terminal device, or is applied to a chip inside the terminal device. In an example, the method is applied to a terminal device. The terminal device receives first indication information and second indication information from a network device. The first indication information indicates at least one first time unit in a time unit set, the time unit set includes at least two time units, and all time units in the time unit set are for a terminal device to receive a first data signal from the network device. The terminal device determines, based on the first indication information and the second indication information, that a first resource in the resource group corresponding to the at least one DMRS port in any one of the at least one first time unit does not carry the first data signal, and that a second resource in the resource group corresponding to the at least one DMRS port in another time unit in the time unit set other than the at least one first time unit carries the first data signal. Further, the terminal device receives the first data signal from the network device on a third resource in all the time units in the time unit set. The third resource includes the second resource and does not include the first resource.

According to a second aspect, a communication method is provided. The method is applied to a network device, or is applied to a chip inside the network device. In an example, the method is applied to a network device. The network device determines first indication information and second indication information. The first indication information indicates at least one first time unit in a time unit set, the time unit set includes at least two time units, all time units in the time unit set are for a terminal device to receive a first data signal from a network device, the second indication information indicates an index of a resource group corresponding to at least one demodulation reference signal DMRS port, and a resource in the resource group corresponding to the at least one DMRS port does not carry a data signal. Then, the network device sends the first indication information and the second indication information to the terminal device, so that the terminal device determines, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal. Further, the network device sends the first data signal to the terminal device on a third resource in all the time units in the time unit set. The third resource includes the second resource and does not include the first resource.

In the solutions of the first aspect and the second aspect, the DMRS port corresponding to the interference signal in each time unit is indicated by a time domain location at which the DMRS is actually sent, that is, a specific feature of the interference signal is described by using each time unit as a dimension, so that the terminal device accurately determines a specific status of the interference signal in each time unit, and accurately demodulates the received first data signal, thereby improving effectiveness and reliability of data transmission.

In at least one embodiment, the first indication information in the first aspect and the second aspect indicates: an index, in the time unit set, of a time unit for sending a DMRS corresponding to the at least one DMRS port in each first time unit; or time domain difference information between a time unit for sending a DMRS corresponding to the at least one DMRS port in each first time unit and the first time unit.

In this solution, the DMRS port corresponding to the interference signal in each time unit and the actual time domain location of the sent DMRS is clearly indicated through the first indication information, so that the terminal device accurately determines the time domain transmission location of the DMRS and receive each DMRS accurately and timely.

According to a third aspect, a communication method is provided. The method is applied to a terminal device, or is applied to a chip inside the terminal device. In an example, the method is applied to a terminal device. The terminal device receives first indication information and second indication information from a network device. The first indication information indicates at least one first time unit in a time unit set, the time unit set includes at least two time units, and all time units in the time unit set are for a terminal device to receive a first data signal from the network device. The terminal device determines, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal. Further, the terminal device receives the first data signal from the network device on a third resource in all the time units in the time unit set. The third resource includes the second resource and does not include the first resource.

According to a fourth aspect, a communication method is provided. The method is applied to a network device, or is applied to a chip inside the network device. In an example, the method is applied to a network device. The network device determines first indication information and second indication information. The first indication information indicates at least one first time unit in a time unit set, the time unit set includes at least two time units, all time units in the time unit set are for a terminal device to receive a first data signal from a network device, the second indication information indicates an index of a resource group corresponding to at least one demodulation reference signal DMRS port, and a resource in the resource group corresponding to the at least one DMRS port does not carry a data signal. Then, the network device sends the first indication information and the second indication information to the terminal device, so that the terminal device determines, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal. Further, the network device sends the first data signal to the terminal device on a third resource in all the time units in the time unit set. The third resource includes the second resource and does not include the first resource.

In the solutions in the third aspect and the fourth aspect, the DMRS port corresponding to each interference signal and time domain location information are indicated, and a specific feature of each interference signal is described in a dimension of each interference signal, so that the terminal device accurately determines a specific status of each interference signal, and accurately demodulates the received first data signal, thereby improving effectiveness and reliability of data transmission.

In at least one embodiment, the first indication information in the third aspect and the fourth aspect indicates: an index of the at least one first time unit in the time unit set; or a time domain start location and a time domain end location of the at least one first time unit in the time unit set; or a time domain start location and time domain duration of the at least one first time unit in the time unit set; or a time domain end location and time domain duration of the at least one first time unit in the time unit set.

In this solution, the time domain location occupied by each interference signal is clearly indicated through the first indication information, so that the terminal device accurately determines the time domain transmission location of the DMRS and receive each DMRS accurately and timely.

In at least one embodiment, the second time unit in the third aspect and the fourth aspect is a time unit that is the first of the at least one first time unit.

In this solution, the DMRS is transmitted in a time unit in the front (namely, a first time unit), and the terminal device receives the DMRS as early as possible, so as to perform data demodulation as soon as possible, thereby reducing a data demodulation delay.

In at least one embodiment, in the solutions corresponding to the first aspect to the fourth aspect, the first indication information and the second indication information are carried in a same field of DCI; or the first indication information and the second indication information are carried in different fields of DCI; or the first indication information is carried in a MAC-CE, and the second indication information is carried in DCI.

In the foregoing solution, both the first indication information and the second indication information is carried by a same piece of signaling (namely, DCI). In this case, the first indication information and the second indication information are sent to the terminal device at the same time. Alternatively, the first indication information and the second indication information is separately carried by different pieces of signaling. In this way, the manner of carrying the first indication information and the second indication information is relatively flexible, and conventional signaling is reused, thereby improving utilization of existing signaling.

In at least one embodiment, in the solutions corresponding to the first aspect to the fourth aspect, a time unit in the time unit set is a slot, and the first resource and the second resource are REs.

According to a fifth aspect, a communication apparatus is provided. The communication apparatus is a terminal device or a chip disposed in the terminal device. The communication apparatus includes a module configured to perform the method in the first aspect or any implementation of the first aspect.

According to a sixth aspect, a communication apparatus is provided. The communication apparatus is a network device or a chip disposed in the network device. The communication apparatus includes a module configured to perform the method in the second aspect or any implementation of the second aspect.

According to a seventh aspect, a communication apparatus is provided. The communication apparatus is a terminal device or a chip disposed in the terminal device. The communication apparatus includes a module configured to perform the method in the third aspect or any implementation of the third aspect.

According to an eighth aspect, a communication apparatus is provided. The communication apparatus is a network device or a chip disposed in the network device. The communication apparatus includes a module configured to perform the method in the fourth aspect or any implementation of the fourth aspect.

According to a ninth aspect, a communication apparatus is provided, including: at least one processor, and a communication interface communicatively connected to the at least one processor, where the at least one processor executes instructions stored in a memory, causing the communication apparatus to perform the method in the first aspect or any implementation of the first aspect through the communication interface.

According to a tenth aspect, a communication apparatus is provided, including: at least one processor, and a communication interface communicatively connected to the at least one processor, where the at least one processor executes instructions stored in a memory, causing the communication apparatus to perform the method in the second aspect or any implementation of the second aspect through the communication interface.

According to an eleventh aspect, a communication apparatus is provided, including: at least one processor, and a communication interface communicatively connected to the at least one processor, where the at least one processor executes instructions stored in a memory, causing the communication apparatus to perform the method in the third aspect or any implementation of the third aspect through the communication interface.

According to a twelfth aspect, a communication apparatus is provided, including: at least one processor, and a communication interface communicatively connected to the at least one processor, where the at least one processor executes instructions stored in a memory, causing the communication apparatus to perform the method in the fourth aspect or any implementation of the fourth aspect through the communication interface.

According to a thirteenth aspect, a computer-readable storage medium is provided, including a program or instructions, in response to the program or the instructions being run on a computer, the method in the first aspect or any implementation of the first aspect being performed.

According to a fourteenth aspect, a computer-readable storage medium is provided, including a program or instructions, in response to the program or the instructions being run on a computer, the method in the second aspect or any implementation of the second aspect being performed.

According to a fifteenth aspect, a computer-readable storage medium is provided, including a program or instructions, in response to the program or the instructions being run on a computer, the method in the third aspect or any implementation of the third aspect being performed.

According to a sixteenth aspect, a computer-readable storage medium is provided, including a program or instructions, in response to the program or the instructions being run on a computer, the method in the fourth aspect or any implementation of the fourth aspect being performed.

According to a seventeenth aspect, a chip is provided. The chip is coupled to a memory, and is configured to read and execute program instructions stored in the memory, so that the method in the first aspect or any implementation of the first aspect is performed.

According to an eighteenth aspect, a chip is provided. The chip is coupled to a memory, and is configured to read and execute program instructions stored in the memory, so that the method in the second aspect or any implementation of the second aspect is performed.

According to a nineteenth aspect, a chip is provided. The chip is coupled to a memory, and is configured to read and execute program instructions stored in the memory, so that the method in the third aspect or any implementation of the third aspect is performed.

According to a twentieth aspect, a chip is provided. The chip is coupled to a memory, and is configured to read and execute program instructions stored in the memory, so that the method in the fourth aspect or any implementation of the fourth aspect is performed.

According to a twenty-first aspect, a computer program product is provided, including instructions. In response to In response to the instructions are run on a computer, the method in the first aspect or any implementation of the first aspect is performed.

According to a twenty-second aspect, a computer program product is provided, including instructions. In response to In response to the instructions are run on a computer, the method in the second aspect or any implementation of the second aspect is performed.

According to a twenty-third aspect, a computer program product is provided, including instructions. In response to In response to the instructions being run on a computer, the method in the third aspect or any implementation of the third aspect is performed.

According to a twenty-fourth aspect, a computer program product is provided, including instructions. In response to the instructions being run on a computer, the method in the fourth aspect or any implementation of the fourth aspect is performed.

The foregoing general descriptions and the following detailed descriptions are merely illustrative and explanatory, and are not intended to limit embodiments described herein.

### BRIEF DESCRIPTION OF DRAWINGS

FIG. 1 is a schematic diagram of an application scenario according to at least one embodiment;

FIG. 2 is a schematic diagram of a MIMO system;

FIG. 3a is a schematic diagram of a time domain resource of a type1 single-symbol DMRS;

FIG. 3b is a schematic diagram of a time domain resource of a type1 double-symbol DMRS;

FIG. 4 is a schematic diagram of data transmission of two UEs by scheduling a plurality of consecutive slots;

FIG. 5 is a flowchart of a communication method according to at least one embodiment;

FIG. 6 is a schematic diagram of a plurality of interference modes according to at least one embodiment;

FIG. 7 is an interaction flowchart of a communication method according to at least one embodiment;

FIG. 8 is another flowchart of a communication method according to at least one embodiment;

FIG. 9 is another interaction flowchart of a communication method according to at least one embodiment;

FIG. 10 is a schematic diagram depicting a structure of a communication apparatus according to at least one embodiment;

FIG. 11 is a schematic diagram depicting a structure of another communication apparatus according to at least one embodiment;

FIG. 12 is a schematic diagram depicting a structure of another communication apparatus according to at least one embodiment;

FIG. 13 is a schematic diagram depicting a structure of another communication apparatus according to at least one embodiment;

FIG. 14 is a schematic diagram depicting a structure of another communication apparatus according to at least one embodiment; and

FIG. 15 is a schematic diagram depicting a structure of another communication apparatus according to at least one embodiment.

### DESCRIPTION OF EMBODIMENTS

To make objectives, technical solutions, and advantages of at least one embodiment clearer, the following further describes at least one embodiment in detail with reference to the accompanying drawings.

The following describes some terms in at least one embodiment, to facilitate understanding of a person skilled in the art.

(1) A terminal device includes a device that provides a user with voice and/or data connectivity, for example, includes a handheld device with a wireless connection function or a processing device connected to a wireless modem. The terminal device communicates with a core network through a radio access network (radio access network, RAN), and exchange voice and/or data with the RAN. The terminal device includes user equipment (user equipment, UE), a terminal, a wireless terminal device, a mobile terminal device, a device-to-device (device-to-device, D2D) communication terminal device, a vehicle-to-everything (vehicle-to-everything, V2X) terminal device, a machine-to-machine/machine-type communications (machine-to-machine/machine-type communications, M2M/MTC) terminal device, an internet of things (internet of things, IoT) terminal device, a subscriber unit (subscriber unit), a subscriber station (subscriber station), a mobile station (mobile station), a remote station (remote station), an access point (access point, AP), a remote terminal (remote terminal), an access terminal (access terminal), a user terminal (user terminal), a user agent (user agent), a user device (user device), or the like. For example, the terminal device includes a mobile phone (or referred to as a “cellular” phone), a computer with a mobile terminal device, or a portable, pocket-sized, handheld, or computer built-in mobile apparatus. For example, the terminal device is a device such as a personal communications service (personal communications service, PCS) phone, a cordless telephone, a session initiation protocol (session initiation protocol, SIP) phone, a wireless local loop (wireless local loop, WLL) station, or a personal digital assistant (personal digital assistant, PDA). The terminal device alternatively includes a limited device, for example, a device with relatively low power consumption, a device with a limited storage capability, or a device with a limited computing capability. For example, the terminal device includes an information sensing device such as a barcode, radio frequency identification (radio frequency identification, RFID), a sensor, a global positioning system (global positioning system, GPS), or a laser scanner.

As an example instead of a limitation, in at least one embodiment, the terminal device is alternatively a wearable device. The wearable device is also referred to as a wearable intelligent device, an intelligent wearable device, or the like, and is a general term of wearable devices that are intelligently designed and developed for daily wear by using a wearable technology, for example, glasses, gloves, watches, clothes, and shoes. The wearable device is a portable device that is directly worn on the body or integrated into clothes or an accessory of a user. The wearable device is not only a hardware device, but also implements a powerful function through software support, data exchange, and cloud interaction. In a broad sense, wearable intelligent devices include full-featured and large-sized devices that implements all or a part of functions without depending on smartphones, for example, smart watches or smart glasses, and include devices that are dedicated to only one type of application function and to collaboratively works with other devices such as smartphones, for example, various smart bands, smart helmets, or smart jewelry for monitoring physical signs.

In response to the various terminal devices described above being located in a vehicle (for example, placed in the vehicle or installed in the vehicle), the terminal devices is all considered as vehicle-mounted terminal devices. For example, the vehicle-mounted terminal devices are also referred to as on-board units (on-board unit, OBU).

(2) A network device includes, for example, an access network (access network, AN) device such as a base station (for example, an access point), and is a device that communicates with a wireless terminal device over an air interface through one or more cells in an access network. Alternatively, for example, an access network device in a V2X technology is a road side unit (road side unit, RSU). The base station is configured to mutually convert a received over-the-air frame and an internet protocol (IP) packet, and serve as a router between the terminal device and a remaining part of the access network. The remaining part of the access network includes an IP network. The RSU is a fixed infrastructure entity supporting a V2X application, and exchanges a message with another entity supporting the V2X application. The access network device further coordinates attribute management of the air interface. For example, the access network device includes an evolved NodeB (NodeB, eNB, or e-NodeB, evolved NodeB) in a long term evolution (long term evolution, LTE) system or a long term evolution-advanced (long term evolution-advanced, LTE-A) system, or includes a next generation NodeB (next generation NodeB, gNB) and a next generation evolved NodeB (next generation evolved NodeB, ng-eNB) in a new radio (new radio, NR) system of the 5th generation (the 5th generation, 5G) mobile communication technology, or includes a central unit (central unit, CU) and a distributed unit (distributed unit, DU) in a separated access network system. This is not limited in at least one embodiment.

Certainly, the network device further includes a core network device, which has an access and mobility management function (access and mobility management function, AMF), and is mainly responsible for functions such as access control, mobility management, attach and detach, and gateway selection. The core network device also has a network data analytics function (network data analytics function, NWDAF), and is mainly responsible for functions such as data collection and analysis. The core network device is alternatively able to be another device.

(3) “At least one” means one or more, and “a plurality of” means two or more. The term “and/or” describes an association relationship between associated objects, and indicates that three relationships exist. For example, A and/or B indicates the following cases: Only A exists, both A and B exist, and only B exists, where A and B is singular or plural. The character “/” generally indicates an “or” relationship between the associated objects.

In addition, unless otherwise stated, ordinal numbers such as “first” and “second” in at least one embodiment are for distinguishing between a plurality of objects, but are not intended to limit an order, a time sequence, priorities, or importance of the plurality of objects. For example, first information and second information are merely intended to distinguish between different pieces of signaling, but do not indicate that the two types of information are different in content, priorities, a sending sequence, importance, or the like.

(4) A time unit involved in at least one embodiment is a slot (slot), a mini-slot (mini-slot), a transmission time interval (transmission time interval, TTI), a subframe, a symbol, or the like.

The foregoing describes some concepts in at least one embodiment, and the following describes technical characteristics in at least one embodiment.

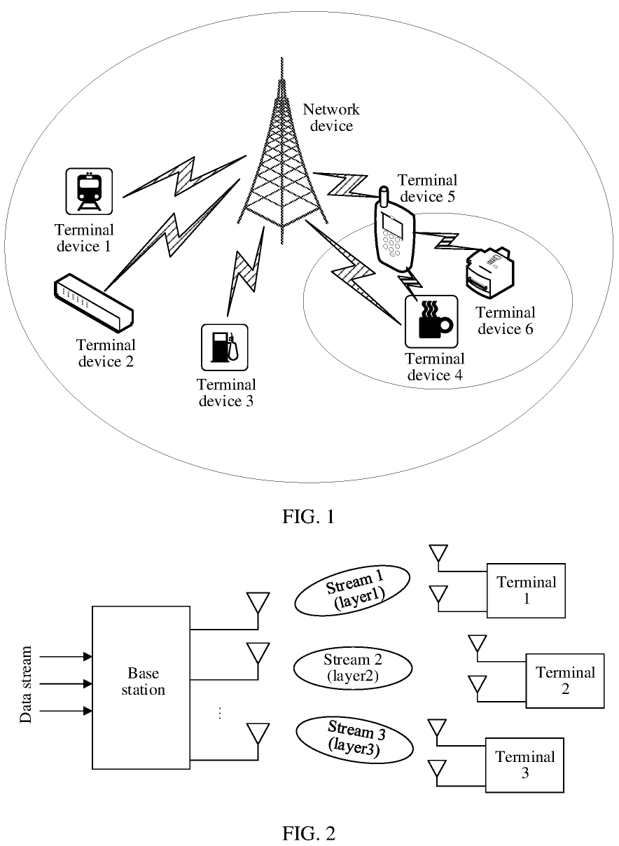

The following describes a network architecture to which at least one embodiment is applied. Refer to FIG. 1.

FIG. 1 includes a network device and a plurality of terminal devices. The network device and the terminal devices 1 to 6 form a communication system. In the communication system, the network device sends information to each terminal device. Correspondingly, each terminal device also sends information to the network device. In addition, the terminal devices 4 to 6 also forms a communication system. In the communication system, the terminal device 5 sends information to either or both of the terminal device 4 and the terminal device 6. These terminal devices in the communication system shown in FIG. 1 includes, for example, devices such as a mobile phone, a television, a gas station device, a printer, a car, a refrigerator, and an air conditioner. These terminal devices is terminal devices in an LTE system, or is terminal devices in a 5G NR system.

The communication system shown in FIG. 1 supports multiple-input multiple-output (multiple-input multiple-output, MIMO) transmission. For example, the network device pairs the terminal device 1 and the terminal device 5, so that the terminal device 1 and the terminal device 5 are paired users. The network device transmits data to the two terminal devices by using a same time-frequency resource. In this way, on the same time-frequency resource, a data signal transmitted by one of the terminal devices becomes an interference signal of the other of the terminal devices. For the terminal device 1, a data signal transmitted by the network device to the terminal device 5 on a same time-frequency resource becomes interference of the terminal device 1 in response to receiving the data signal on the time-frequency resource. Therefore, in response to receiving the data signal sent by the network device, the terminal device 1 actually further includes data sent by the network device to the terminal device 5. To accurately demodulate data, the terminal device 1 not only performs channel estimation on the terminal device 1, but also performs channel estimation on the terminal device 5.

A communication system involved in at least one embodiment is, for example, a long term evolution (long term evolution, LTE) system, a 5^{th} generation communication system (5^{th} generation mobile networks or 5^{th} generation wireless systems, 5G), or a hybrid architecture of LTE and 5G.

The technical solutions provided in at least one embodiment is applied to a service scenario of wireless to the X (wireless to the X, WTTx), and supports large-packet transmission (high throughput) by relying on a wireless technology in 4G LTE or 5G NR. In this service scenario, compared with a network device (for example, a base station), a location of a terminal (for example, a customer premise equipment (customer premise equipment, CPE), which receives a mobile signal and forward the mobile signal by a wireless-fidelity (wireless-fidelity, Wi-Fi) signal) basically remains unchanged. Related field measurement and research also indicate that a radio channel between the base station and the terminal basically remains unchanged within a period of time, that is, has a quasi-static feature. Therefore, downlink single-user transmission is used as an example. In a set of consecutive slots, the base station sends only one physical downlink control channel (physical downlink control channel, PDCCH) carrying downlink control information (downlink control information, DCI) to continuously schedule a plurality of transmission blocks (transmission block, TB), and send a DMRS only in a first downlink slot. A channel estimation result of the first slot is reused for the remaining slots, so that overheads are reduced, and more time-frequency resources are used for downlink data transmission.

In a MIMO system, a plurality of transmitting antennas and receiving antennas are configured at a transmit end and a receive end, which is equivalent to increasing available channel resources in a spatial dimension. Therefore, a system capacity is multiplied without increasing spectrum resources and antenna transmit power. Therefore, since 4G LTE, the MIMO technology is considered as a key technology for improving system performance. The MIMO technology supports different users to send or receive data on a same time-frequency resource, in other words, supports different users to reuse the same time-frequency resource to send and receive data, thereby improving a total uplink and downlink transmission rate. Users who reuse the same time-frequency resource (REs on a same orthogonal frequency division multiplexing (orthogonal frequency division multiplexing, OFDM) symbol) is also referred to as paired users (co-scheduled UE). These users transmit data in parallel on different spatial domain resources (streams and layers). Data on different streams is mapped to different antenna ports for transmission according to a mapping relationship agreed between a base station and a terminal. The MIMO system that simultaneously serves a plurality of users is referred to as multi-user MIMO (MU-MIMO), as shown in FIG. 2.

The following describes a DMRS port in NR.

There are two types of NR DMRSs: a front-loaded DMRS (front loaded DMRS) and an additional DMRS (additional DMRS) (also referred to as an additional DMRS). The following provides descriptions.

### 1 Front-Loaded DMRS

To reduce demodulation and decoding delays, a front-loaded design is used for a DMRS of a data channel (physical downlink shared channel (physical downlink shared channel, PDSCH)/physical uplink shared channel (physical uplink shared channel, PUSCH)) in an NR system. In each scheduling time unit (for example, each slot), a location at which the DMRS first appears should be as close to a scheduling start point. For example, in slot-based scheduling transmission, a location of the front-loaded DMRS is adjacent to a PDCCH area and after the PDCCH area. In this case, a specific location of a first symbol of the front-loaded DMRS depends on a configuration of the PDCCH, and is a third or fourth symbol. During mini-slot scheduling transmission, the front-loaded DMRS starts to be transmitted from the first symbol of the scheduling area. The use of the front-loaded DMRS helps a receive end to start channel estimation and receive detection early, and plays an important role in reducing a delay and supporting a self-contained frame structure.

DMRS ports are multiplexed in a frequency division multiplexing (frequency-division multiplexing, FDM) + code division multiplexing (code division multiplexing, CDM) manner. Each CDM group is divided into a plurality of ports through an orthogonal cover code (orthogonal cover code, OCC), and CDM groups are distinguished in an FDM manner.

NR supports two DMRS types (type), and a used DMRS type is configured through higher layer signaling. The NR DMRS includes one (that is, a single-symbol DMRS) or two (that is, a double-symbol DMRS) OFDM symbols. Multiplexing and configuration manners of the two DMRS types are specifically described as follows.

### (1) A DMRS Type 1, Namely, a DMRS Type1

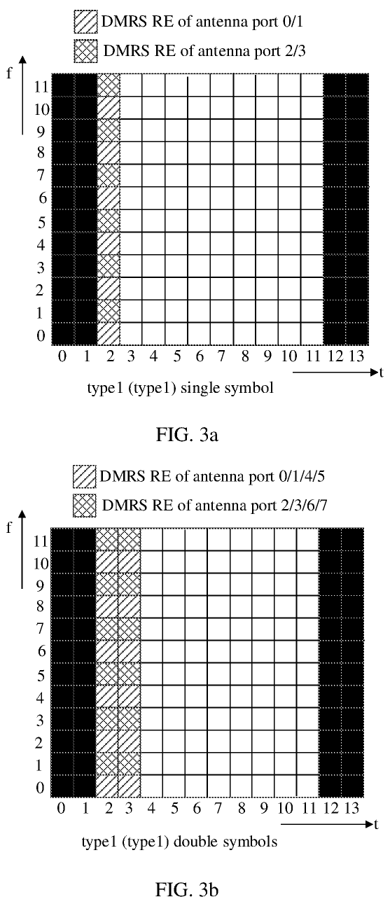

FIG. 3a shows port mapping of a DMRS of type1 with a single symbol. For a single-symbol DMRS, subcarriers in one OFDM symbol are divided into two groups of frequency-division comb resources, and each group of comb resources forms one CDM group. The CDM group supports multiplexing of two ports through two OCCs, and at most four ports are supported, for example, ports 0, 1, 2, and 3 (or ports 1000, 1001, 1002, and 1003).

Further, FIG. 3b shows port mapping of a DMRS of type1 with double symbols. Based on the single-symbol structure, a time-domain OCC (Time Domain OCC, TD-OCC) is added in the double-symbol DMRS. Each group of comb resources occupies two consecutive OFDM symbols. Each CDM group implements four orthogonal ports through four OCCs in the time-frequency domain. Therefore, at most eight orthogonal ports are supported.

### (2) A DMRS Type 2, Namely, a DMRS Type 2

For a type2 single-symbol DMRS, subcarriers in an OFDM symbol are divided into three CDM groups, and each CDM group consists of two pairs of adjacent subcarriers. The CDM group supports multiplexing of two ports through two OCCs, and the CDM groups are distinguished in an FDM manner. Therefore, at most six ports are supported.

For a type2 double-symbol DMRS, a TD-OCC is added based on a structure of the type2 single-symbol DMRS. Each CDM group occupies two consecutive OFDM symbols. Each CDM group supports four orthogonal ports through four OCCs in the time-frequency domain. Three CDM groups support at most 12 ports.

In summary, for a type1 DMRS, a single symbol supports at most four antenna ports, and double symbols support at most eight antenna ports; and for a type2 DMRS, a single symbol supports at most six antenna ports, and double symbols support at most 12 antenna ports.

### 2 Additional DMRS

In high-speed mobility scenarios, in addition to the DMRS, more DMRS symbols are inserted in scheduling duration to ensure the accuracy of time-varying channel estimation. In an NR system, a structure in which a front-loaded DMRS is combined with an additional DMRS whose time domain density is configurable is used. A pattern of each group of additional DMRSs is a repetition of the front-loaded DMRS. Therefore, consistent with the front-loaded DMRS, each group of additional DMRSs occupies at most two consecutive OFDM symbols. At most three groups of additional DMRSs is configured based on a specific application scenario and mobility. The quantity of additional DMRSs depends on a higher-layer parameter configuration and specific scheduling duration.

For ease of understanding, the following first describes interference cancellation in a related technology.

In an LTE downlink interference cancellation mechanism, a base station notifies, through DCI, a terminal device of information such as an antenna port occupied by an interference signal, and a quantity of streams, to assist the terminal in performing interference measurement and cancellation on a scheduled time-frequency resource.

Similarly, in NR, the base station notifies, through an antenna port field in the DCI, the terminal of:
1. ports occupied by DMRSs sent to a PDSCH of the terminal; and
2. RE locations that do not carry downlink data.

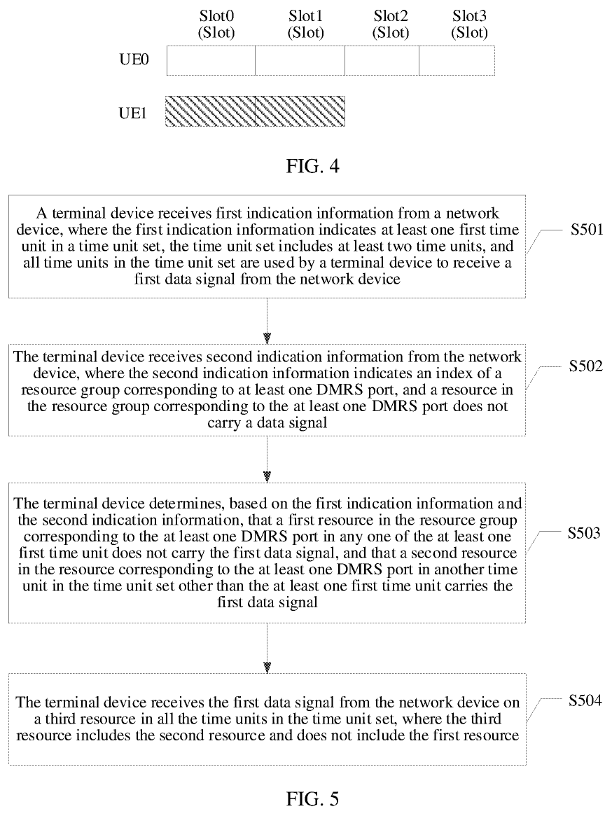

In some service scenarios (for example, a WTTx service), a network device schedules a plurality of TBs in a set of consecutive slots. For example, as shown in FIG. 4, the network device schedules a downlink service of four slots long (that is, slot0 to slot3) for UE0, and pairs UE1 with the UE0. Therefore, the UE0 and the UE1 is referred to as paired users. The network device schedules a downlink service of two slots long (that is, slot0 and slot1) for the UE1. The network device sends, in slot0 to the UE0, a DMRS for the UE0 to perform channel estimation, and notifies, through DCI, the UE0 of a port used to receive the DMRS. After receiving the DCI, the UE0 determines to receive, in slot0, the DMRS used for channel estimation of the UE0. In addition, because the DMRS is broadcast, the UE0 further receives a DMRS that occupies another DMRS port and is used for channel estimation of the UE1. In this way, after receiving all DMRSs sent by the network device, the UE0 performs channel estimation on a channel carrying downlink data sent to this UE (a stream occupied by the channel is the same as a stream corresponding to the DMRS port occupied by this UE) and a channel carrying downlink data sent to the paired UE (a stream occupied by the channel is the same as a stream corresponding to the DMRS port occupied by the paired UE, and is different from that of the DMRS port occupied by this UE), so as to accurately demodulate the downlink data sent to this UE.

In the foregoing service scenario, for interference, that exists in subsequent slots (that is, slot1 to slot3), caused by the downlink data of the paired user to demodulation of the downlink data of this user, in one manner, the UE0 reuses an estimation result of a corresponding channel on a DMRS port occupied by the UE0 + interference in slot0 to perform data demodulation. However, in practice, a time resource occupied by the paired UE is variable, that is, a DMRS port occupied by the paired UE in the subsequent slot is different from that in slot0, so the method of reusing the channel estimation result cannot flexibly match a pairing status. In some cases, a DMRS port occupied by the paired user in some slots is vacant in the subsequent slot, and an RE corresponding to the DMRS port could have carried downlink data sent to the UE0, causing resource waste.

To further describe the technical solutions provided in at least one embodiment, the following describes the technical solutions in detail with reference to the accompanying drawings and specific implementations. Although at least one embodiment provides operation steps of methods shown in the following embodiments or accompanying drawings, the methods includes more or fewer operation steps based on conventional or no creative effort. In steps that logically have no necessary causal relationship, an order of performing these steps is not limited to the order of performing these steps provided in at least one embodiment. In response to the method being actually processed or performed by an apparatus, the method is performed in an order of the method shown in the embodiments or the accompanying drawings, or is performed in parallel.

The technical solutions provided in at least one embodiment are described below with reference to the accompanying drawings.

FIG. 5 is a flowchart of a communication method according to at least one embodiment. For example, the communication method is performed by a terminal device. The process shown in FIG. 5 is described as follows.

Step 501: A terminal device receives first indication information from a network device, where the first indication information indicates at least one first time unit in a time unit set, the time unit set includes at least two time units, and all time units in the time unit set are for the terminal device to receive a first data signal from the network device.

As described above, the network device schedules a plurality of consecutive TBs for the terminal device through a consecutive time unit set, for example, schedules a plurality of TBs for transmission through consecutive slots. Therefore, the terminal device receives, in each time unit in the time unit set, data sent by the network device. In other words, all time units in the time unit set are for the terminal device to receive data from the network device. For example, the data received by the terminal device from the network device is referred to as a first data signal.

The time unit set in at least one embodiment includes at least two time units. For example, the time unit set includes slot0, slot1, slot2, and slot3 shown in FIG. 4. In other words, the time unit set includes four consecutive slots.

In at least one embodiment, the first indication information indicates at least one first time unit in the time unit set. A time unit in the time unit set indicated by the first indication information is referred to as a first time unit. Therefore, any first time unit indicated by the first indication information is a time unit in the time unit set. The at least one first time unit is one or more time units in the time unit set, and the at least one first time unit is all or some time units in the time unit set. This is not limited in at least one embodiment.

Step 502: The terminal device receives second indication information from the network device, where the second indication information indicates an index of a resource group corresponding to at least one DMRS port, and a resource in the resource group corresponding to the at least one DMRS port does not carry a data signal.

Because the resource in the resource group corresponding to the at least one DMRS port does not carry the data signal, the resource group that is corresponding to the at least one DMRS port and that is indicated by the second indication information is, for example, CDM Group without data, including one or more of CDM0, CDM1, and CDM2. Correspondingly, the index of the resource group is, for example, at least one of 1, 2, and 3. In response to the index of the resource group being 1, the resource group corresponds to CDM0. In response to the index of the resource group being 2, the resource group corresponds to CDM0 and CDM1. In response to the index of the resource group being 3, the resource group corresponds to CDM0, CDM1, and CDM2.

The resource group corresponding to the DMRS port does not carry the data signal, that is, the resource included in the resource group does not carry the data signal. The resource group that does not carry the data signal carries a DMRS signal. Therefore, the resource group that is corresponding to the DMRS port and that does not carry the data signal is understood as a resource group that carries the DMRS. In other words, the resource group that is corresponding to the at least one DMRS port and that is indicated by the second indication information carries the DMRS. For example, the resource group carries the DMRS used for channel estimation of the terminal device, and also carries a DMRS used for channel estimation of another terminal device (for example, another terminal device paired with the terminal device).

Step 503: The terminal device determines, based on the first indication information and the second indication information, that a first resource in the resource group corresponding to the at least one DMRS port in any one of the at least one first time unit does not carry the first data signal, and that a second resource in the resource group corresponding to the at least one DMRS port in another time unit in the time unit set other than the at least one first time unit carries the first data signal.

According to indication of the first indication information and the second indication information, the terminal device determines that the first resource in the resource group corresponding to the at least one DMRS port in any one of the at least one first time unit (that is, each first time unit) does not carry the first data signal. In other words, a resource that does not carry the first data signal and that is in a CDM group corresponding to a DMRS port in each first time unit is determined. For ease of understanding, in at least one embodiment, the resource that is in the CDM group corresponding to the DMRS port in the first time unit and that does not carry the first data signal is referred to as a “first resource”, and not carrying data is implicitly understood as carrying the DMRS, that is, the first resource carries the DMRS. A resource in the CDM group is, for example, an RE. Different indexes of the CDM group represent different Res. In other words, the network device clearly notifies the terminal device of a time domain resource (namely, a time unit) and a frequency domain resource (namely, an RE) used to receive the DMRS. In this case, the terminal device determines, according to the indication of the first indication information and the second indication information, time-frequency resources on which the DMRS is received. The DMRS received by the terminal device on these time-frequency resources includes a DMRS used for channel estimation of the terminal device, and further includes a DMRS used for channel estimation of another terminal device (for example, a paired terminal).

Refer to the configuration of the antenna port field in the DCI corresponding to the type1 single-symbol DMRS shown in Table 1. In this case, the antenna port field includes 4 bits, and therefore, a value of the bit field of the antenna port field is 0 to 15.

TABLE 1

One codeword (the codeword 0 is enabled, and the codeword 1 is disabled)

| Bit field value | CDM group without data | DMRS port |
|---|---|---|
| 0 | 1 | 0 |
| 1 | 1 | 1 |
| 2 | 1 | 0,1 |
| 3 | 2 | 0 |
| 4 | 2 | 1 |
| 5 | 2 | 2 |
| 6 | 2 | 3 |
| 7 | 2 | 0,1 |
| 8 | 2 | 2,3 |
| 9 | 2 | 0-2 |
| 10 | 2 | 0-3 |
| 11 | 2 | 0,2 |
| 12-15 | Reserved | Reserved |

In response to a value of the antenna port field being 0, an index of a corresponding CDM group in the CDM group without data is 1. Because the CDM group whose index is 1 is the CDM0, indicates that an RE resource included in the CDM0 does not carry data. In other words, the RE resource included in the CDM0 is used to transmit the DMRS. In addition, because the antenna ports 1000 and 1001 match and correspond to the CDM0, the antenna ports 1002 and 1003 match and correspond to the CDM1, and the third column (namely, the DMRS port) in Table 1 indicates that the antenna port of the DMRS for the terminal device to perform channel estimation of the terminal device is 1000, the terminal device infers that only the DMRS port 1001 has a DMRS that has an interference signal.

That is, the frequency domain resource used to transmit the DMRS in each time unit is indicated by using a time unit as a dimension through the second indication information. In this way, the terminal device determines, according to the indication of the first indication information and the second indication information, the frequency domain resource used to transmit the DMRS in each first time unit. In all the DMRSs received by the terminal device in all the first time units, except the DMRS used for channel estimation of the terminal device, the other DMRSs is considered as DMRSs corresponding to the interference signal. Further, a DMRS port corresponding to each interference signal is determined according to Table 1 above.

In addition, the terminal device further determines that the second resource in the resource group corresponding to the at least one DMRS port in another time unit in the time unit set other than the at least one first time unit carries the first data signal, that is, determines time-frequency resources on which the data sent by the network device is received. For ease of understanding, in at least one embodiment, the data received by the terminal device from the network device is referred to as the first data signal. In response to there being no interference, the first data signal includes only a data signal sent by the network device to the terminal device. However, in response to there being an interference, the first data signal not only includes a data signal sent by the network device to the terminal device, but also includes an interference signal. The interference signal is, for example, a data signal sent by the network device to another terminal device on a same time-frequency resource (that is, a time-frequency resource on which the network device sends the data signal to the terminal device).

To be specific, according to the indication of the first indication information and the second indication information, the terminal device learns that the DMRS is received on a frequency domain resource (for example, an RE) corresponding to each time unit (namely, a time domain resource). The received DMRS is used to estimate a channel carrying downlink data of the terminal device. In response to there being an interference, a plurality of DMRSs is received. In addition to the DMRS for the terminal device to perform channel estimation of the terminal device, the other DMRSs are for the terminal device to estimate a channel on another stream, that is, channel estimation is performed on a stream for transmitting an interference signal. In other words, a DMRS port and a frequency domain resource corresponding to an interference signal (if any) in each time unit is indicated to the terminal device. The terminal device determines time units in which the DMRS exists, and determines frequency domain resources and DMRS ports on which the DMRS is received in response to the DMRS exists in a time unit. In this way, a related feature of the interference signal in each time unit is clearly indicated to the terminal device.

Step 504: The terminal device receives the first data signal from the network device on a third resource in all the time units in the time unit set, where the third resource includes the second resource and does not include the first resource.

In the related technology, a DMRS for a terminal device to perform channel estimation in a time unit is generally received in the time unit. In response to there is an interference, a DMRS used to perform channel estimation for an interference signal is also received in the time unit. However, in an actual interference scenario, the DMRS used to perform channel estimation for the interference signal is usually not sent in the time unit. Therefore, to improve accuracy of interference channel estimation, at least one embodiment provides a solution to perform indication in each time unit, specifically, indicating that a DMRS used for channel estimation in a current time unit is from another time unit. In other words, the DMRS used for channel estimation in the time unit is transmitted in another time unit, and the DMRS transmitted in another time unit is a DMRS corresponding to the interference signal. Therefore, a frequency domain resource (for example, an RE) of the DMRS corresponding to the interference signal in each time unit is determined according to the indication of the first indication information and the second indication information.

According to the indication of the first indication information and the second indication information, the terminal device determines the time-frequency resource used to receive the DMRS and the time-frequency resource used to receive the first data signal. For example, the terminal device receives, on the third resource, the first data signal sent by the network device. Because the RE used to transmit the DMRS cannot be used to transmit the data signal, and as described in the step 503, the resource for the terminal device to receive the data signal is the third resource, the third resource that is finally actually for the terminal device to receive the first data signal includes the second resource and does not include the first resource. In other words, the third resource belongs to the second resource and does not belong to the first resource.

In an actual transmission scenario, the first data signal received by the terminal device may or may not be interfered with. In response to there being an interference, interference cancellation is performed to implement accurate data demodulation.

The DMRS is received on the first resource in each first time unit determined above. For the received DMRS, in addition to the DMRS for the terminal device for channel estimation of the terminal device, in response to the received DMRS further includes another DMRS, the another DMRS is understood as a DMRS corresponding to an interference signal. For ease of description, for example, the DMRS for the terminal device for channel estimation of the terminal device is referred to as a first DMRS, and the DMRS corresponding to the interference signal is referred to as a second DMRS. Therefore, in addition to the first DMRS, in response to the received DMRS further including the second DMRS, is inferred that there is an interference in the first data signal received by the terminal device, and a quantity of interference signals is correspondingly determined based on a quantity of included second DMRSs, that is, the quantity of second DMRSs is equal to the quantity of interference signals.

In this way, the terminal device not only receives the first data signal on the third resource, but also receive the first DMRS and the second DMRS (in response to there being an interference signal) on the first resource in each first time unit. Further, after receiving, on the third resource, the first data signal sent by the network device, the terminal device performs, through the first DMRS used for channel estimation of the terminal device, channel estimation on a channel of the terminal device, and perform, through the second DMRS, channel estimation on a channel on which an interference signal is sent, and performs interference cancellation on the first data signal based on channel estimation results of the first DMRS and the second DMRS, to implement accurate data demodulation, to obtain data actually to be sent by the network device to the terminal device.

In at least one embodiment, the first indication information indicates at least one first time unit in the time unit set. The terminal device determines, based on the first indication information, a first resource that is in any first time unit and that does not carry the first data signal, that is, determines a frequency domain resource for the terminal device to receive the DMRS. In other words, the network device transmits the DMRS to the terminal device in the first time unit in the time unit set, and indicates, through the second indication information, a frequency domain resource (for example, an RE resource) used to transmit the DMRS to the terminal device. In at least one embodiment, there is a resource used to transmit the DMRS of the interference signal in the resource corresponding to the CDM group in the first time unit indicated by the first indication information. In this manner, the network device indicates, through the first indication information, the DMRS port of each interference signal to the terminal device, so that the terminal device accurately receives the DMRS of each interference signal on the corresponding resource, thereby achieving accurate interference cancellation and improving effectiveness and reliability of data transmission.

In a specific implementation, the first indication information indicates an index, in the time unit set, of a time unit for sending a DMRS corresponding to the at least one DMRS port in each first time unit. In this way, an actual time domain location for sending the DMRS corresponding to the at least one DMRS port in each first time unit is clearly known, so that the terminal device accurately receives the DMRS.

In at least one embodiment, the first indication information indicates time domain difference information between a time unit for sending a DMRS corresponding to the at least one DMRS port in each first time unit and the first time unit. For example, a first time unit is slot2. The first indication information indicates time domain difference information between slot2 and the time unit for actually sending the DMRS corresponding to the at least one DMRS port in slot2. The time domain difference information includes time domain interval length information, and the time domain interval length information indicates a quantity of time units between two time units. For example, in response to the time domain difference information indicating that the quantity of time units between two time units is 1, a time unit actually for sending a DMRS is slot1, that is, a previous slot adjacent to slot2. Because the time unit actually for sending the DMRS is generally earlier than a time unit indicating a DMRS port corresponding to the DMRS, the time unit actually for sending the DMRS is before the time unit indicating the DMRS port corresponding to the DMRS. In a specific implementation, the time unit for actually sending the DMRS and the time unit for indicating the DMRS port corresponding to the DMRS is a same time unit, then the quantity of time units between two time units indicated by the time domain difference information is 0. In this case, the terminal device not only receives, in one time unit, a DMRS used for channel estimation of the terminal device, but also receive, in the time unit, a DMRS used for channel estimation of a stream of an interference signal.

In other words, actual time domain location information for sending a DMRS signal is further indicated by the first indication information. In this way, the terminal device accurately and quickly receives the DMRS signal at the corresponding time domain location, thereby improving accuracy of data demodulation, and further improving efficiency of data demodulation.

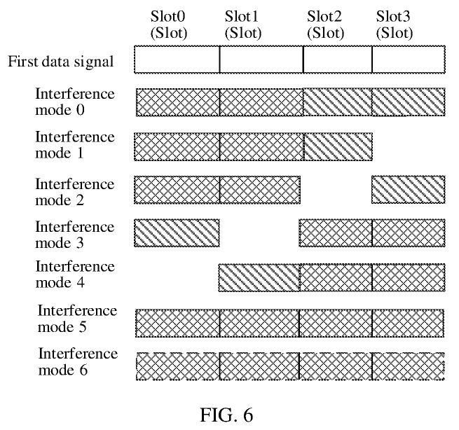

The DMRS configuration in Table 1 is used as an example. Refer to some possible interference cases corresponding to the first data signal scheduled in four consecutive slots shown in FIG. 6. For example, each interference case is referred to as an interference mode, and a DMRS port of an interference signal + an actual time-domain sending location of a DMRS are shown in Table 2.

TABLE 2

| Index value | Interference mode |
|---|---|
| 0 | Without interference |
| 1 | The interference is from a port 1, and the DMRS is sent in this slot |
| 2 | The interference is from a port 1, and the DMRS is sent in a previous slot |
| 3 | Reserved |

Based on the foregoing analysis, time units in the time unit set other than the first time unit is referred to as other time units. In other words, the time unit set consists of the first time unit and other time units. The first time unit indicates a DMRS port of an existing interference signal. In a specific implementation, the following cases is included.

Case 1. All time units in the time unit set are the first time units, that is, there is an interference signal in each time unit in the time unit set. In this case, other time units are an empty set, as an interference mode 0 and an interference mode 5 shown in FIG. 6. In the interference mode 0, two interference signals are included, one interference signal occupies slots slot0 and slot1, and the other interference signal occupies slots slot2 and slot3. In the interference mode 5, one interference signal is included, and the interference signal occupies four consecutive slots.

Case 2. Some time units in the time unit set are the first time units, that is, there are interference signals only in some time units in the time unit set. In this case, other time units and the first time units are not empty sets, as an interference mode 1, an interference mode 2, an interference mode 3, and an interference mode 4 shown in the figure. Using the interference mode 2 as an example, two interference signals are included, one interference signal occupies slots slot0 and slot1, and the other interference signal occupies only slot3. There is no interference in slot2.

Case 3. The time unit set does not include the first time unit, that is, there is no interference in the time unit set. In this case, the first time unit is an empty set, and other time units are all time units in the time unit set, as an interference mode 6 in FIG. 6. In the interference mode 6 in FIG. 6, a dashed line indicates that there is no interference in a slot corresponding to the dashed line, that is, there is no interference in the entire slot set. This corresponds to an SU-MIMO service scenario.

In a specific implementation, the first indication information and the second indication information is carried in a same field in the DCI, for example, both are carried in an antenna port field in the DCI, and different interference modes in Table 2 is indicated by different values of the antenna port field. Alternatively, the first indication information and the second indication information is carried in different fields in the DCI. For example, the second indication information is carried in the antenna port field in the DCI, and the first indication information is carried in another field in the DCI. Alternatively, the first indication information and the second indication information is carried through different pieces of signaling. For example, the first indication information is carried through a MAC-CE, and the second indication information is carried through DCI. In this way, the existing signaling and some fields in the existing signaling are reused, so that a specific feature of each interference signal is clearly indicated to the terminal device, thereby improving clarity and effectiveness of the interference indication. In addition, the first indication information and the second indication information are simultaneously indicated through the same piece of signaling, or the first indication information and the second indication information are separately indicated through different pieces of signaling. In this way, the indication of the first indication information and the second indication information is more flexible.

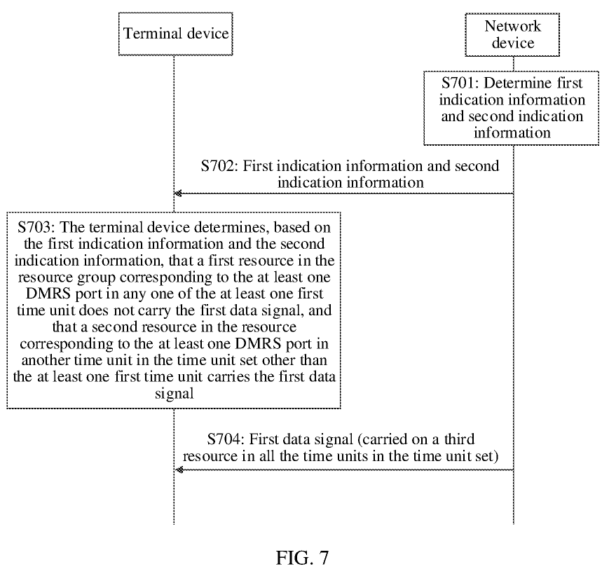

Further, refer to an interaction flowchart shown in FIG. 7. Based on FIG. 5, FIG. 7 describes a communication method in at least one embodiment from a perspective of interaction between a terminal device and a network device.

Step 701: A network device determines first indication information and second indication information.

For the first indication information and the second indication information, refer to the descriptions of the first indication information and the second indication information in FIG. 5.

Step 702: The network device sends the first indication information and the second indication information to a terminal device, and the terminal device receives the first indication information and the second indication information that are sent by the network device.

In a specific implementation, the first indication information and the second indication information is sent at the same time, or is sent successively. As described above, in response to the first indication information and the second indication information being carried in a same piece of signaling (for example, DCI), the first indication information and the second indication information is sent at the same time; and in response to the first indication information and the second indication information being carried in different pieces of signaling, the first indication information and the second indication information is sent successively. This is not limited in at least one embodiment.

Step 703: The terminal device determines, based on the first indication information and the second indication information, that a first resource in the resource group corresponding to the at least one DMRS port in any one of the at least one first time unit does not carry the first data signal, and that a second resource in the resource group corresponding to the at least one DMRS port in another time unit in the time unit set other than the at least one first time unit carries the first data signal.

For implementation of the step 703, refer to the foregoing description of the step 503, and details are not described herein again.

Step 704: The network device sends the first data signal to the terminal device on a third resource in all the time units in the time unit set, and the terminal device receives the first data signal from the network device on the third resource in all the time units in the time unit set.

As described above, the third resource includes the second resource and does not include the first resource.

For description of a specific embodiment of FIG. 7, refer to the embodiment of FIG. 5, and details are not described herein again.

In the embodiments corresponding to FIG. 5 and FIG. 7, the DMRS port corresponding to the interference signal in each time unit is indicated by a time domain location at which the DMRS is actually sent, that is, a specific feature of the interference signal is described by using each time unit as a dimension, so that the terminal device accurately determines a specific status of the interference signal in each time unit, and accurately demodulates the received first data signal, thereby improving effectiveness and reliability of data transmission.

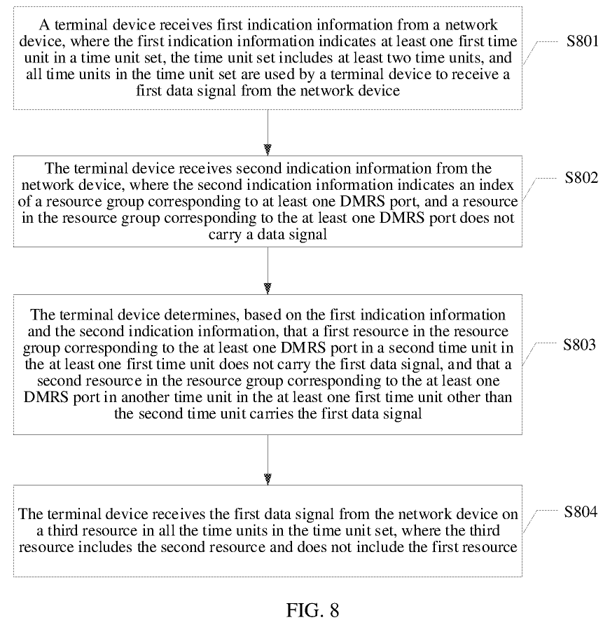

FIG. 8 is a flowchart of another communication method according to at least one embodiment. For example, the communication method is performed by a terminal device. The process shown in FIG. 8 is described as follows.

Step 801: A terminal device receives first indication information from a network device, where the first indication information indicates at least one first time unit in a time unit set, the time unit set includes at least two time units, and all time units in the time unit set are for a terminal device to receive a first data signal from the network device.

Implementation of the step 801 is similar to implementation of the step 501 in FIG. 5. Therefore, for description of the embodiment of the step 801, refer to the foregoing description of the step 501.

Step 802: The terminal device receives second indication information from the network device, where the second indication information indicates an index of a resource group corresponding to at least one DMRS port, and a resource in the resource group corresponding to the at least one DMRS port does not carry a data signal.

Implementation of the step 802 is similar to implementation of the step 502 in FIG. 5. Therefore, for description of the embodiment of the step 802, refer to the foregoing description of the step 502.

Step 803: The terminal device determines, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal.

The second time unit is a time unit in the at least one first time unit. The second time unit includes one first time unit, or includes a plurality of first time units. In response to the second time unit including a plurality of first time units, the second time unit includes a plurality of first time units that are consecutive in the time domain, or includes a plurality of first time units that are inconsecutive in the time domain.

The at least one first time unit includes one second time unit, or includes a plurality of second time units. The first resource in the resource group corresponding to the at least one DMRS port in the second time unit does not carry the first data signal. The first resource in the resource group corresponding to the at least one DMRS port in the second time unit carries a DMRS, for example, carries a DMRS used to estimate a channel of data received by the terminal device, and carries a DMRS used to estimate a stream of data (for example, an interference signal) received by another terminal device. That is, the terminal device receives the DMRS on the frequency domain resource corresponding to the second time unit. The received DMRS includes a DMRS for channel estimation of the terminal device, and further includes a DMRS corresponding to an interference signal. In addition, as the terminal device generally receives the DMRS used for channel estimation of the terminal device only once, the DMRS received on the frequency domain resource corresponding to the second time unit is only the DMRS corresponding to the interference signal.

In at least one embodiment, interference is indicated by using the second time unit as an indication granularity in all the first time units. In other words, each interference signal that exists in the at least one time unit is indicated by using an interference signal as a dimension, and one second time unit corresponds to one interference signal.

In an implementation, the second time unit includes a time unit that is the first of the at least one first time unit. In this way, the DMRS is pre-sent, that is, the DMRS is transmitted in a time unit in the front (namely, a first time unit) in a plurality of scheduled slots, so that a data demodulation delay is reduced, and a network delay is reduced.

Step 804: The terminal device receives the first data signal from the network device on a third resource in all the time units in the time unit set, where the third resource includes the second resource and does not include the first resource.

Implementation of the step 804 is similar to implementation of the step 504 in FIG. 5. Therefore, for description of the embodiment of the step 804, refer to the foregoing description of the step 504.

In a specific implementation, the first indication information indicates at least one of the following information:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

(1) An index of the at least one first time unit in the time unit set. Each time unit in the time unit set has an index. For example, indexes corresponding to four slots: slot0 to slot3, in FIG. 4 are respectively 0, 1, 2, and 3. Therefore, the network device clearly indicates the index of the at least one first time unit to the terminal device. For example, in response to the indicated indexes of the at least one first time unit being 0 and 1, both slot0 and slot1 in slot0 to slot3 are first time units in the time unit set.

(2) A time domain start location and a time domain end location of the at least one first time unit in the time unit set. For example, there are two first time units. Still as shown in FIG. 4, assuming that the two first time units are slot0 and slot1, the two first time units is represented by the time domain start location and the time domain end location in the time unit set. For example, in response to the time domain start location being slot0, and the time domain end location being slot1, one of the first time units is slot0, and the other of the first time units is slot1.

(3) A time domain start location and time domain duration of the at least one first time unit in the time unit set. For example, there are two first time units. Still as shown in FIG. 4, assuming that the two first time units are slot0 and slot1, correspondingly, the time domain start location is slot0, and the time domain duration is 2, that is, two time units starting from slot0. In another example, there are four first time units. Assuming that the four first time units are slot0 to slot3, the corresponding time domain start location is slot0, and the time domain duration is 4.

(4) A time domain end location and time domain duration of the at least one first time unit in the time unit set. For example, there are two first time units. Still as shown in FIG. 4, assuming that the two first time units are slot0 and slot1, the corresponding time domain end location is slot1, and the time domain duration is 2, that is, all time units two time units before the time domain end location is the at least one first time unit.

Refer to some interference cases corresponding to the first data signal scheduled in four consecutive slots shown in FIG. 6. For example, each interference case is referred to as an interference mode, and FIG. 6 shows seven interference modes, which are specifically shown in Table 3 below.

TABLE 3

| Index value | CDM group without data | DMRS port occupied by interference | Interference mode |
|---|---|---|---|
| 0 | 1 | 1001 | Interference 1: start from slot0 for duration of 2; Interference 2: start from slot2 for duration of 2. |
| 1 | 1 | 1001 | Interference 1: start from slot0 for duration of 2; Interference 2: start from slot2 for duration of 1. |
| 2 | 1 | 1001 | Interference 1: start from slot0 for duration of 2; Interference 2: start from slot3 for duration of 1. |
| 3 | 1 | 1001 | Interference 1: start from slot0 for duration of 1; Interference 2: start from slot2 for duration of 2. |
| 4 | 1 | 1001 | Interference 1: start from slot1 for duration of 1; Interference 2: start from slot2 for duration of 2. |
| 5 | 1 | 1001 | Interference 1: start from slot0 for duration of 4. |
| 6 | 1 | 1001 | Without interference |
| 7 | Reserved | Reserved | Reserved |

Based on the foregoing analysis, time units in the time unit set other than the first time unit is referred to as other time units. In other words, the time unit set consists of the first time unit and other time units. The first time unit indicates a DMRS port of an existing interference signal. In a specific implementation, the following cases is included.

Case 1. All time units in the time unit set are the first time units, that is, there is an interference signal in each time unit in the time unit set. In this case, other time units are an empty set, as an interference mode 0 and an interference mode 5 shown in FIG. 6. In the interference mode 0, two interference signals are included, one interference signal occupies slots slot0 and slot1, and the other interference signal occupies slots slot2 and slot3. In the interference mode 5, one interference signal is included, and the interference signal occupies four consecutive slots.

Case 2. Some time units in the time unit set are the first time units, that is, there are interference signals only in some time units in the time unit set. In this case, other time units and the first time units are not empty sets, as an interference mode 1, an interference mode 2, an interference mode 3, and an interference mode 4 shown in the figure. Using the interference mode 2 as an example, two interference signals are included, one interference signal occupies slots slot0 and slot1, and the other interference signal occupies only slot3. There is no interference in slot2.

Case 3. The time unit set does not include the first time unit, that is, there is no interference in the time unit set. In this case, the first time unit is an empty set, and other time units are all time units in the time unit set, as an interference mode 6 in FIG. 6. In the interference mode 6 in FIG. 6, a dashed line indicates that there is no interference in a slot corresponding to the dashed line, that is, there is no interference in the entire slot set. This corresponds to an SU-MIMO service scenario.

In a specific implementation, the first indication information and the second indication information is carried in a same field in the DCI, for example, both are carried in an antenna port field in the DCI, and different interference modes in Table 2 is indicated by different values of the antenna port field. Alternatively, the first indication information and the second indication information is carried in different fields in the DCI. For example, the second indication information is carried in the antenna port field in the DCI, and the first indication information is carried in another field in the DCI. Alternatively, the first indication information and the second indication information is carried through different pieces of signaling. For example, the first indication information is carried through a MAC-CE, and the second indication information is carried through DCI. In this way, the existing signaling and some fields in the existing signaling are reused, so that a specific feature of each interference signal is clearly indicated to the terminal device, thereby improving clarity and effectiveness of the interference indication.

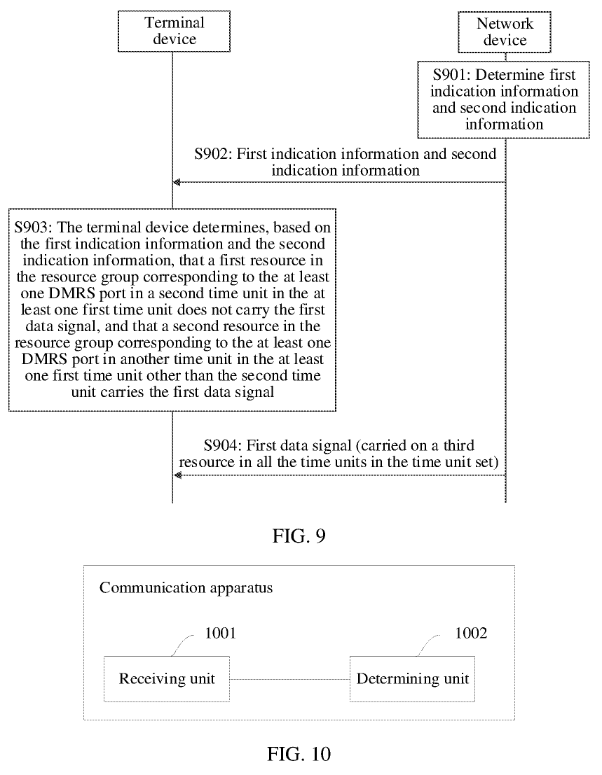

Further, refer to an interaction flowchart shown in FIG. 9. Based on FIG. 8, FIG. 9 describes a communication method in at least one embodiment from a perspective of interaction between a terminal device and a network device.

Step 901: A network device determines first indication information and second indication information.

For the first indication information and the second indication information, refer to the descriptions of the first indication information and the second indication information in FIG. 8.

Step 902: The network device sends the first indication information and the second indication information to a terminal device, and the terminal device receives the first indication information and the second indication information that are sent by the network device.

In a specific implementation, the first indication information and the second indication information is sent at the same time, or is sent successively. As described above, in response to the first indication information and the second indication information being carried in a same piece of signaling (for example, DCI), the first indication information and the second indication information is sent at the same time; and in response to the first indication information and the second indication information being carried in different pieces of signaling, the first indication information and the second indication information is sent successively. This is not limited in at least one embodiment.

Step 903: The terminal device determines, based on the first indication information and the second indication information, that a first resource in the resource group corresponding to the at least one DMRS port in any one of the at least one first time unit does not carry the first data signal, and that a second resource in the resource group corresponding to the at least one DMRS port in another time unit in the time unit set other than the at least one first time unit carries the first data signal.

For implementation of the step 903, refer to the foregoing description of the step 803, and details are not described herein again.

Step 904: The network device sends the first data signal to the terminal device on a third resource in all the time units in the time unit set, and the terminal device receives the first data signal from the network device on the third resource in all the time units in the time unit set.

As described above, the third resource includes the second resource and does not include the first resource.

For description of a specific embodiment of FIG. 9, refer to the embodiment of FIG. 8, and details are not described herein again.

In the embodiments corresponding to FIG. 8 and FIG. 9, the DMRS port corresponding to each interference signal and time domain location information are indicated, and a specific feature of each interference signal is described in a dimension of each interference signal, so that the terminal device accurately determines a specific status of each interference signal, and accurately demodulates the received first data signal, thereby improving effectiveness and reliability of data transmission.

FIG. 5 to FIG. 7 describe a solution for indicating an interference signal, and FIG. 8 and FIG. 9 describe another solution for indicating an interference signal. In FIG. 5 to FIG. 7, a specific feature of an interference signal in each time unit is indicated by using a time unit as a dimension. As described above, one interference signal spans a plurality of time units. In this case, a specific feature of a complete interference signal is determined through indication information of the interference signal in a plurality of time units. In FIG. 8 and FIG. 9, a specific feature of each interference signal is indicated by using an interference signal as a dimension, and one interference signal occupies only one time unit or spans a plurality of time units.

The technical solutions shown in FIG. 5 to FIG. 7 and FIG. 8 to FIG. 9 implements clear indication of an interference signal. In response to there being a large quantity of total interference modes in a slot set (mainly depending on a DMRS configuration, a multi-user pairing status under the influence of channel conditions, and a downlink service complexity), compared with the solution in FIG. 5 to FIG. 7, fewer bits are allocated in the solution in FIG. 8 and FIG. 9. In response to there being a small quantity of total interference modes, in the solution in FIG. 5 to FIG. 7, the method of allocating bits to each slot reduces redundancy. Therefore, the two solutions each have a suitable application condition. A specific solution to be used is flexibly configured by a network device or manually. This is not limited in at least one embodiment.

Based on a same technical concept, at least one embodiment provides a communication apparatus. The communication apparatus is a terminal device or a chip disposed in the terminal device. The communication apparatus has a function of implementing the terminal device in the embodiments shown in FIG. 5 to FIG. 7. For example, the communication apparatus includes corresponding modules, units, or means (means) for performing the steps performed by the terminal device in the embodiments shown in FIG. 5 to FIG. 7. The functions units or means is implemented by software, is implemented by hardware, or is implemented by hardware executing corresponding software. Refer to FIG. 10 for an example. A communication apparatus in at least one embodiment includes a receiving unit 1001 and a determining unit 1002.

The receiving unit 1001 is configured to receive first indication information from a network device, where the first indication information indicates at least one first time unit in a time unit set, the time unit set includes at least two time units, and all time units in the time unit set are for a terminal device to receive a first data signal from the network device.

The receiving unit 1001 is further configured to receive second indication information from the network device, where the second indication information indicates an index of a resource group corresponding to at least one DMRS port, and a resource in the resource group corresponding to the at least one DMRS port does not carry a data signal.

The determining unit 1002 is configured to determine, based on the first indication information and the second indication information, that a first resource in the resource group corresponding to the at least one DMRS port in any one of the at least one first time unit does not carry the first data signal, and that a second resource in the resource group corresponding to the at least one DMRS port in another time unit in the time unit set other than the at least one first time unit carries the first data signal.

The receiving unit 1001 is further configured to receive the first data signal from the network device on a third resource in all the time units in the time unit set, where the third resource includes the second resource and does not include the first resource.

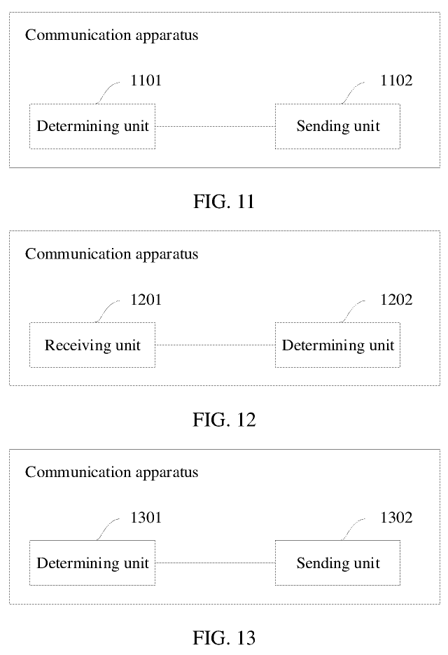

Based on a same inventive concept, at least one embodiment provides a communication apparatus. The communication apparatus is a network device or a chip disposed in the network device. The communication apparatus has a function of implementing the network device in the embodiments shown in FIG. 5 to FIG. 7. For example, the communication apparatus includes corresponding modules, units, or means (means) for performing the steps performed by the network device in the embodiments shown in FIG. 5 to FIG. 7. The functions, units, or means is implemented by software, is implemented by hardware, or is implemented by hardware executing corresponding software. Refer to FIG. 11 for an example. A communication apparatus in at least one embodiment includes a determining unit 1101 and a sending unit 1102.

The determining unit 1101 is configured to determine first indication information and second indication information, where the first indication information indicates at least one first time unit in a time unit set, the time unit set includes at least two time units, all time units in the time unit set are for a terminal device to receive a first data signal from a network device, the second indication information indicates an index of a resource group corresponding to at least one DMRS port, and a resource in the resource group corresponding to the at least one DMRS port does not carry a data signal.

The sending unit 1102 is configured to send the first indication information and the second indication information to the terminal device, where the first indication information and the second indication information are for the terminal device to determine that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal.

The sending unit 1102 is further configured to send the first data signal to the terminal device on a third resource in all the time units in the time unit set, where the third resource includes the second resource and does not include the first resource.

For the communication apparatuses shown in FIG. 10 and FIG. 11, in at least one embodiment, the first indication information indicates an index, in a time unit set, of a time unit for sending a DMRS corresponding to at least one DMRS port in each first time unit, or time domain difference information between a time unit for sending a DMRS corresponding to at least one DMRS port in each first time unit and the first time unit.

Based on a same technical concept, at least one embodiment provides a communication apparatus. The communication apparatus is a terminal device or a chip disposed in the terminal device. The communication apparatus has a function of implementing the terminal device in the embodiments shown in FIG. 8 to FIG. 9. For example, the communication apparatus includes corresponding modules, units, or means (means) for performing the steps performed by the terminal device in the embodiments shown in FIG. 8 to FIG. 9. The functions, units, or means is implemented by software, is implemented by hardware, or is implemented by hardware executing corresponding software. Refer to FIG. 12 for an example. A communication apparatus in at least one embodiment includes a receiving unit 1201 and a determining unit 1202.

The receiving unit 1201 is configured to receive first indication information from a network device, where the first indication information indicates at least one first time unit in a time unit set, the time unit set includes at least two time units, and all time units in the time unit set are for a terminal device to receive a first data signal from the network device.

The receiving unit 1201 is further configured to receive second indication information from the network device, where the second indication information indicates an index of a resource group corresponding to at least one DMRS port, and a resource in the resource group corresponding to the at least one DMRS port does not carry a data signal.

The determining unit 1202 is configured to determine, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal.

The receiving unit 1201 is further configured to receive the first data signal from the network device on a third resource in all the time units in the time unit set, where the third resource includes the second resource and does not include the first resource.

Based on a same technical concept, at least one embodiment provides a communication apparatus. The communication apparatus is a network device or a chip disposed in the network device. The communication apparatus has a function of implementing the network device in the embodiments shown in FIG. 8 to FIG. 9. For example, the communication apparatus includes corresponding modules, units, or means (means) for performing the steps performed by the network device in the embodiments shown in FIG. 8 to FIG. 9. The functions, units, or means is implemented by software, is implemented by hardware, or is implemented by hardware executing corresponding software. Refer to FIG. 13 for an example. A communication apparatus in at least one embodiment includes a determining unit 1301 and a sending unit 1302.

The determining unit 1301 is configured to determine first indication information and second indication information, where the first indication information indicates at least one first time unit in a time unit set, the time unit set includes at least two time units, all time units in the time unit set are for a terminal device to receive a first data signal from a network device, the second indication information indicates an index of a resource group corresponding to at least one DMRS port, and a resource in the resource group corresponding to the at least one DMRS port does not carry a data signal.

The sending unit 1302 is configured to send the first indication information and the second indication information to the terminal device, where the first indication information and the second indication information are for the terminal device to determine that a first resource in the resource group corresponding to the at least one DMRS port in a second time unit in the at least one first time unit does not carry the first data signal, and that a second resource in the resource group corresponding to the at least one DMRS port in another time unit in the at least one first time unit other than the second time unit carries the first data signal.

The sending unit 1302 is further configured to send the first data signal to the terminal device on a third resource in all the time units in the time unit set, where the third resource includes the second resource and does not include the first resource.

For the communication apparatuses shown in FIG. 12 and FIG. 13, in at least one embodiment, the first indication information indicates:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

In at least one embodiment, the second time unit includes a time unit that is the first of the at least one first time unit.

For the communication apparatuses shown in FIG. 12 and FIG. 13, in at least one embodiment, the second time unit includes a time unit that is the first of the at least one first time unit.

For the communication apparatuses shown in FIG. 10 to FIG. 13, in at least one embodiment, the first indication information and the second indication information are carried in a same field of DCI; or the first indication information and the second indication information are carried in different fields of DCI; or the first indication information is carried in a MAC-CE, and the second indication information is carried in DCI.

For the communication apparatuses shown in FIG. 10 to FIG. 13, in at least one embodiment, a time unit in the time unit set is a slot, and the first resource and the second resource are REs.

Based on a same technical concept, refer to FIG. 14. An embodiment of this application further provides a communication apparatus, including: at least one processor 1401, and a communication interface 1403 communicatively connected to the at least one processor 1401. The at least one processor 1401 executes instructions stored in a memory 1402, causing the communication apparatus to perform, through the communication interface 1403, the method steps performed by the terminal device in the embodiments shown in FIG. 5 to FIG. 7, or to perform the method steps performed by the terminal device in the embodiments shown in FIG. 8 and FIG. 9.

Optionally, the memory 1402 is located outside the communication apparatus.

Optionally, the communication apparatus includes the memory 1402, the memory 1402 is connected to the at least one processor 1401, and the memory 1402 stores instructions that is executed by the at least one processor 1401. In FIG. 14, a dashed line indicates that the memory 1402 is optional for the communication apparatus.

The at least one processor 1401 and the memory 1402 is coupled to each other by an interface circuit, or is integrated together. This is not limited herein.

A specific connection medium among the processor 1401, the memory 1402, and the communication interface 1403 is not limited in at least one embodiment. In at least one embodiment, the processor 1401, the memory 1402, and the communication interface 1403 are connected by a bus 1404 in FIG. 14. The bus is represented by a bold line in FIG. 14. A connection manner among other components is merely an example for description, and is not limited thereto. The bus is classified into an address bus, a data bus, a control bus, and the like. For ease of representation, only one bold line represents the bus in FIG. 14, but this does not mean that there is only one bus or only one type of bus.

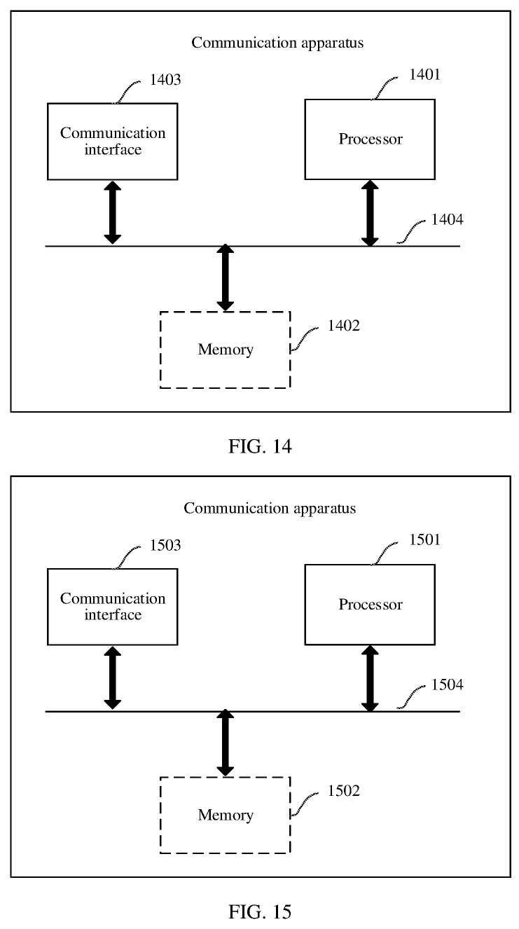

Based on a same technical concept, refer to FIG. 15. An embodiment of this application further provides a communication apparatus, including: at least one processor 1501, and a communication interface 1503 communicatively connected to the at least one processor 1501. The at least one processor 1501 executes instructions stored in a memory 1502, causing the communication apparatus to perform, through the communication interface 1503, the method steps performed by the network device in the embodiments shown in FIG. 5 to FIG. 7, or to perform the method steps performed by the network device in the embodiments shown in FIG. 8 and FIG. 9.

Optionally, the memory 1502 is located outside the communication apparatus.

Optionally, the communication apparatus includes the memory 1502, the memory 1502 is connected to the at least one processor 1501, and the memory 1502 stores instructions that is executed by the at least one processor 1501. In FIG. 15, a dashed line indicates that the memory 1502 is optional for the communication apparatus.

The processor 1501 and the memory 1502 is coupled to each other by an interface circuit, or is integrated together. This is not limited herein.

A specific connection medium among the processor 1501, the memory 1502, and the communication interface 1503 is not limited in at least one embodiment. In at least one embodiment, the processor 1501, the memory 1502, and the communication interface 1503 are connected by a bus 1504 in FIG. 15. The bus is represented by a bold line in FIG. 15. A connection manner among other components is merely an example for description, and is not limited thereto. The bus is classified into an address bus, a data bus, a control bus, and the like. For ease of representation, only one bold line represents the bus in FIG. 15, but this does not mean that there is only one bus or only one type of bus.

The processor mentioned in at least one embodiment is implemented by hardware or is implemented by software. In response to the processor being implemented by the hardware, the processor is a logic circuit, an integrated circuit, or the like. In response to the processor being implemented by the software, the processor is a general-purpose processor, and is implemented by reading software code stored in the memory.

For example, the processor is a central processing unit (central processing unit, CPU), or is another general-purpose processor, a digital signal processor (digital signal processor, DSP), an application-specific integrated circuit (application specific integrated circuit, ASIC), a field programmable gate array (field programmable gate array, FPGA) or another programmable logic device, a discrete gate or transistor logic device, a discrete hardware component, or the like. The general-purpose processor is a microprocessor, or the processor is any conventional processor or the like.

The memory mentioned in at least one embodiment is a volatile memory or a nonvolatile memory, or includes a volatile memory and a nonvolatile memory. The nonvolatile memory is a read-only memory (Read-Only Memory, ROM), a programmable read-only memory (programmable ROM, PROM), an erasable programmable read-only memory (Erasable PROM, EPROM), an electrically erasable programmable read-only memory (electrically EPROM, EEPROM), or a flash memory. The volatile memory is a random access memory (random access memory, RAM), used as an external cache. By way of example but not limitation, many forms of RAMs is used, such as a static random access memory (static RAM, SRAM), a dynamic random access memory (dynamic RAM, DRAM), a synchronous dynamic random access memory (synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchlink dynamic random access memory (Synchlink DRAM, SLDRAM), and a direct rambus random access memory (Direct Rambus RAM, DR RAM).

In response to the processor being a general-purpose processor, a DSP, an ASIC, an FPGA, another programmable logic device, a discrete gate or a transistor logic device, or a discrete hardware component, the memory (storage module) is integrated into the processor.

The memory described in this specification aims to include but is not limited to these memories and any memory of another proper type.

Based on a same technical concept, at least one embodiment further provides a communication system. The communication system includes the communication apparatus in FIG. 10 and the communication apparatus in FIG. 11, or includes the communication apparatus in FIG. 12 and the communication apparatus in FIG. 13, or includes the communication apparatus in FIG. 14 and the communication apparatus in FIG. 15.

Based on a same technical concept, at least one embodiment further provides a computer-readable storage medium, including a program or instructions. In response to the program or the instructions being run on a computer, the method performed by the terminal device in the embodiments shown in FIG. 5 to FIG. 7 or the embodiments shown in FIG. 8 and FIG. 9 is performed.

Based on a same technical concept, at least one embodiment further provides a computer-readable storage medium, including a program or instructions. In response to the program or the instructions being run on a computer, the method performed by the network device in the embodiments shown in FIG. 5 to FIG. 7 or the embodiments shown in FIG. 8 and FIG. 9 is performed.

Based on a same technical concept, at least one embodiment further provides a chip. The chip is coupled to a memory, and is configured to read and execute program instructions stored in the memory, so that the method performed by the terminal device in the embodiments shown in FIG. 5 to FIG. 7 or the embodiments shown in FIG. 8 and FIG. 9 is performed.

Based on a same technical concept, at least one embodiment further provides a chip. The chip is coupled to a memory, and is configured to read and execute program instructions stored in the memory, so that the method performed by the network device in the embodiments shown in FIG. 5 to FIG. 7 or the embodiments shown in FIG. 8 and FIG. 9 is performed.

Based on a same technical concept, at least one embodiment further provides a computer program product, including instructions. In response to the instructions being run on a computer, the method performed by the terminal device in the embodiments shown in FIG. 5 to FIG. 7 or the embodiments shown in FIG. 8 and FIG. 9 is performed.

Based on a same technical concept, at least one embodiment further provides a computer program product, including instructions. In response to the instructions being run on a computer, the method performed by the network device in the embodiments shown in FIG. 5 to FIG. 7 or the embodiments shown in FIG. 8 and FIG. 9 is performed.

Embodiments herein are described with reference to the flowcharts and/or block diagrams of the method, the device (system), and the computer program product according to at least one embodiment. Computer program instructions are used to implement each process and/or each block in the flowcharts and/or the block diagrams and a combination of processes and/or blocks in the flowcharts and/or the block diagrams. These computer program instructions are provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

All or some of the foregoing embodiments are implemented by using software, hardware, firmware, or any combination thereof. In response to software being used to implement the embodiments, all or a part of the embodiments are implemented in a form of a computer program product. The computer program product includes one or more computer instructions. In response to the computer program instructions being loaded and executed on the computer, the procedure or functions according to at least one embodiment are all or partially generated. The computer is a general-purpose computer, a dedicated computer, a computer network, or other programmable apparatuses. The computer instructions are stored in a computer-readable storage medium or are transmitted from a computer-readable storage medium to another readable storage medium. For example, the computer instructions are transmitted from a website, computer, server, or data center to another website, computer, server, or data center in a wired (for example, a coaxial cable, an optical fiber, or a digital subscriber line (digital subscriber line, DSL)) or wireless (for example, infrared, radio, or microwave) manner. The computer-readable storage medium is any usable medium accessible by the computer, or a data storage device, for example, a server or a data center, integrating one or more usable media. The usable medium is a magnetic medium (for example, a floppy disk, a hard disk, or a magnetic tape), an optical medium (for example, a digital versatile disc (digital versatile disc, DVD)), a semiconductor medium (for example, a solid-state drive (solid-state drive, SSD)), or the like.

Clearly, a person skilled in the art is able to make various modifications and variations to at least one embodiment without departing from the spirit and scope of embodiment described herein. Embodiments described herein are intended to cover these modifications and variations provided that they fall within the scope of protection defined by the following claims and their equivalent technologies.

1. A communication method, comprising:
receiving first indication information from a network device, wherein the first indication information indicates at least one first time unit in a time unit set, the time unit set includes at least two time units, and all time units in the time unit set are for a terminal device to receive a first data signal from the network device;
receiving second indication information from the network device, wherein the second indication information indicates an index of a resource group corresponding to at least one demodulation reference signal DMRS port, and a resource in the resource group corresponding to the at least one DMRS port does not carry a data signal;
determining, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the time unit set other than the second time unit carries the first data signal; and
receiving the first data signal from the network device on a third resource in all the time units in the time unit set, wherein the third resource includes the second resource and does not include the first resource.

2. The method according to claim 1, wherein the receiving the first indication information includes receiving the first indication information that indicates:
an index, in the time unit set, of a time unit for sending a DMRS corresponding to the at least one DMRS port in each first time unit; or
time domain difference information between a time unit for sending a DMRS corresponding to the at least one DMRS port in each first time unit and the first time unit.

3. The method according to claim 1, wherein the receiving the first indication information includes receiving the first indication information that indicates:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

4. The method according to claim 1, wherein the receiving the first indication information indicating the at least one first time unit in the time unit set includes receiving the receiving first indication information indicating the second time unit is the first of the at least one first time unit; or
the second time unit is any one of the at least one first time unit.

5. The method according to claim 1, wherein the receiving the first indication information indicating the at least one first time unit in the time unit set includes receiving the receiving first indication information indicating a time unit in the time unit set is a slot, and the first resource and the second resource are resource elements RE.

6. A communication method, comprising:
determining first indication information and second indication information, wherein the first indication information indicates at least one first time unit in a time unit set, the time unit set includes at least two time units, all time units in the time unit set are for a terminal device to receive a first data signal from a network device, the second indication information indicates an index of a resource group corresponding to at least one demodulation reference signal DMRS port, and a resource in the resource group corresponding to the at least one DMRS port does not carry a data signal;
sending the first indication information and the second indication information to the terminal device, wherein the first indication information and the second indication information are associated with a first resource and a second resource; and
sending the first data signal to the terminal device on a third resource in all the time units in the time unit set, wherein the third resource includes a second resource and does not include the first resource, wherein the first resource in the resource group corresponding to the at least one DMRS port in a second time unit in the at least one first time unit does not carry the first data signal, and the second resource in the resource group corresponding to the at least one DMRS port in another time unit in the at least one first time unit other than the second time unit carries the first data signal.

7. The method according to claim 6, wherein the determining the first indication information includes determining the first indication information indicates:
an index, in the time unit set, of a time unit for sending a DMRS corresponding to the at least one DMRS port in each first time unit; or
time domain difference information between a time unit for sending a DMRS corresponding to the at least one DMRS port in each first time unit and the first time unit.

8. The method according to claim 6, wherein the determining the first indication information includes determining the first indication information indicates:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

9. The method according to claim 6, wherein the determining the first indication information indicating at least one first time unit in a time unit set includes determining the first indication information indicates the second time unit is the first of the at least one first time unit; or
the second time unit is any one of the at least one first time unit.

10. The method according to claim 6, wherein the determining the first indication information indicating the at least one first time unit in the time unit set includes determining the first indication information indicates a time unit in the time unit set is a slot, and the first resource and the second resource are resource elements RE.

11. A terminal device, comprising:
a memory storing programming instructions;
at least one processor connected to the memory, wherein the at least one processor is configured to execute the programming instructions to perform operations for:
receiving first indication information from a network device, wherein the first indication information indicates at least one first time unit in a time unit set, the time unit set includes at least two time units, and all time units in the time unit set are for a terminal device to receive a first data signal from the network device;
receiving second indication information from the network device, wherein the second indication information indicates an index of a resource group corresponding to at least one demodulation reference signal DMRS port, and a resource in the resource group corresponding to the at least one DMRS port does not carry a data signal;
determining, based on the first indication information and the second indication information, that a first resource in the resource group corresponding to the at least one DMRS port in a second time unit in the at least one first time unit does not carry the first data signal, and that a second resource in the resource group corresponding to the at least one DMRS port in another time unit in the time unit set other than the second time unit carries the first data signal; and
receiving the first data signal from the network device on a third resource in all the time units in the time unit set, wherein the third resource includes the second resource and does not include the first resource.

12. The apparatus according to claim 11, wherein the first indication information indicates:
an index, in the time unit set, of a time unit for sending a DMRS corresponding to the at least one DMRS port in each first time unit; or
time domain difference information between a time unit for sending a DMRS corresponding to the at least one DMRS port in each first time unit and the first time unit.

13. The apparatus according to claim 11, wherein the first indication information indicates:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

14. The apparatus according to claim 11, wherein the second time unit includes a time unit that is the first of the at least one first time unit; or
the second time unit is any one of the at least one first time unit.

15. The apparatus according to claim 11, wherein the at least one first time unit in the time unit set is a slot, and the first resource and the second resource are resource elements RE.

16. A terminal device, comprising:
a memory storing programming instructions;
at least one processor connected to the memory, wherein the at least one processor is configured to execute the programming instructions to perform operations for:
determining first indication information and second indication information, wherein the first indication information indicates at least one first time unit in a time unit set, the time unit set includes at least two time units, all time units in the time unit set are for a terminal device to receive a first data signal from a network device, the second indication information indicates an index of a resource group corresponding to at least one demodulation reference signal DMRS port, and a resource in the resource group corresponding to the at least one DMRS port does not carry a data signal;
sending the first indication information and the second indication information to the terminal device, wherein the first indication information and the second indication information are associated with a first resource and a second resource; and
sending the first data signal to the terminal device on a third resource in all the time units in the time unit set, wherein the third resource includes a second resource and does not include the first resource, wherein the first resource in the resource group corresponding to the at least one DMRS port in a second time unit in the at least one first time unit does not carry the first data signal, and the second resource in the resource group corresponding to the at least one DMRS port in another time unit in the at least one first time unit other than the second time unit carries the first data signal.

17. The apparatus according to claim 16, wherein the first indication information indicates:
an index, in the time unit set, of a time unit for sending a DMRS corresponding to the at least one DMRS port in each first time unit; or
time domain difference information between a time unit for sending a DMRS corresponding to the at least one DMRS port in each first time unit and the first time unit.

18. The apparatus according to claim 16, wherein the first indication information indicates:
an index of the at least one first time unit in the time unit set; or
a time domain start location and a time domain end location of the at least one first time unit in the time unit set; or
a time domain start location and time domain duration of the at least one first time unit in the time unit set; or
a time domain end location and time domain duration of the at least one first time unit in the time unit set.

19. The apparatus according to claim 16, wherein the second time unit includes a time unit that is the first of the at least one first time unit; or
the second time unit is any one of the at least one first time unit.

20. The apparatus according to claim 16, wherein the at least one first time unit in the time unit set is a slot, and the first resource and the second resource are resource elements RE.
